(19) United States
(12) Patent Application Publication
(10) Pub. No.: US 2025/0128345 A1
(43) Pub. Date: Apr. 24, 2025

(54) ROBOTIC WELDING SYSTEMS WITH INTERMEDIATE TOUCH SENSE POSITIONS

(71) Applicant: ILLINOIS TOOL WORKS INC., Glenview, IL (US)

(72) Inventors: Jeremy Daniel Overesch, JR., Neenah, WI (US); David Ward Savage, Aurora, IL (US)

(21) Appl. No.: 18/924,137

(22) Filed: Oct. 23, 2024

Related U.S. Application Data
(60) Provisional application No. 63/592,300, filed on Oct. 23, 2023.

(51) Int. Cl. B23K 9/095; B25J 11/00

(52) U.S. Cl. CPC B23K 9/0956; B23K 9/0953; B25J 11/005

(57) ABSTRACT

In some examples, a robotic welding system includes an improved touch sensing process that identifies an intermediate position to which to move a welding-type tool and/or electrode between certain touches of the touch sensing process. Use of an intermediate position between certain touches may reduce the potential for accidental and/or unintentional contact with the part, which may be detrimental to a robotic welding process. The improved touch sense process may additionally automatically move the welding-type tool and/or welding electrode to the intermediate position between certain touches. Automatic movement to the intermediate position (e.g., rather than manual operator induced movement) may save the operator time and/or guard against human error and/or forgetfulness.

### CROSS REFERENCE TO RELATED APPLICATIONS

This application claims priority to, and the benefit of, U.S. Provisional Patent Application No. 63/592,300, filed Oct. 23, 2023, entitled “Robotic Welding Systems with Intermediate Touch Sense Positions,” the entire contents of which is hereby incorporated by reference.

### TECHNICAL FIELD

The present disclosure generally relates to robotic welding systems, and, more particularly, robotic welding systems with intermediate touch sense positions.

### BACKGROUND

Robots are sometimes used to perform welding operations. Robots may be efficient and/or effective at repeatedly performing the same welding-type operation over and over with no boredom, loss of interest, lack of attention, and/or need for bathroom/coffee/lunch breaks. With the ongoing shortage of qualified welding operators, robots may be used more and more to help perform welding operations.

Limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure is directed to robotic welding systems with intermediate touch sense positions, substantially as illustrated by and/or described in connection with at least one of the figures, and as set forth more completely in the claims.

These and other advantages, aspects and novel features of the present disclosure, as well as details of an illustrated example thereof, will be more fully understood from the following description and drawings.

### BRIEF DESCRIPTION OF THE DRAWINGS

FIG. 1 shows an example robotic welding system, in accordance with aspects of this disclosure.

FIG. 2 is a block diagram showing additional components and interconnections of the robotic welding system of FIG. 1, in accordance with aspects of this disclosure.

FIG. 3 is a flow diagram illustrating an example operation of a robotic welding process of the robotic welding system of FIGS. 1-2, in accordance with aspects of this disclosure.

FIG. 4 is a flow diagram illustrating an example operation of a touch sense process of the robotic welding process of FIG. 3, in accordance with aspects of this disclosure.

FIGS. 5a-5b illustrate how an actual position of a part may be offset from and/or different than a programmed and/or expected position of the part, in accordance with aspects of this disclosure.

FIGS. 6a-6b and 7a-7c illustrate how movement of the welding-type tool and/or welding electrode from one touch sense position directly to another touch sense position may result in accidental and/or unintentional contact between the part and the welding-type tool and/or welding electrode, in accordance with aspects of this disclosure.

FIGS. 6c-6d and 7d-7e illustrate how movement of the welding-type tool and/or welding electrode to an intermediate position, between touch sense positions, may help to avoid contact between the part and the welding-type tool and/or welding electrode, in accordance with aspects of this disclosure.

The figures are not necessarily to scale. Where appropriate, the same or similar reference numerals are used in the figures to refer to similar or identical elements.

### DETAILED DESCRIPTION

Robotic systems may be programmed to perform welding-type operations along a programmed welding path. The programmed welding path may be defined by two or more programmed welding points/positions on a part, according to an expected part position. However, because of variations in the actual positioning of parts, the programmed welding positions may need to be recalibrated before each welding-type operation to conform to the actual positioning of the part.

Touch sensing is one way of automatically calibrating the robotic system to recognize the actual position of each new part. Touch sensing involves moving the welding-type tool towards a part until a welding electrode extending from an end of the welding-type tool (or the welding-type tool itself) makes contact with (and/or touches) the part. The contact may be detected by a touch sensor, and the robotic system may record the position of the welding electrode (and/or welding-type tool) when contact is made as corresponding to a position of the part. By performing multiple touches, the system can automatically determine the actual position of the part.

Determination of the actual position of at least some points on the part require at least three touches (e.g., to determine the x, y, and z components of a position). Each touch is achieved as part of a touch sense search that begins at a starting position and ends at an end position (with the touch occurring between the start and end). However, due to uncertainties in the position of the part, there is some risk that moving from an end position of one touch sense search to the starting position of another touch sense search will result in unintentional and/or accidental contact between the welding electrode (and/or welding-type tool) and the part.

Unintentional and/or accidental contact between the welding electrode (and/or welding-type tool) and the part may have several detrimental effects. For example, the unintentional and/or accidental contact may move the part, and therefore potentially render invalid prior touch sense positioning determinations. As another example, the unintentional and/or accidental contact may damage the part, damage the welding-type tool and/or welding electrode, and/or cause a false touch detection.

The present disclosure contemplates automatically identifying an appropriate intermediate position, and then moving the welding-type tool and/or welding electrode from an end position of one touch sense search to the intermediate position, before then moving the welding-type tool and/or welding electrode from the intermediate position to the starting position of the next touch sense search. Movement to the intermediate position may reduce the potential for accidental and/or unintentional contact. Additionally, automatic identification of, and/or automatic movement of the welding-type tool and/or welding electrode to, the intermediate position may be more accurate, take less time, and/or be less susceptible to error and/or forgetfulness than manual identification of, and/or movement to, the intermediate position (e.g., by the operator).

Some examples of the present disclosure relate to a non-transitory computer readable medium comprising machine readable instructions which, when executed by a processor, cause the processor to: move, via a robot, a welding-type tool in a first direction, until a touch sensor detects that the welding-type tool, or a welding electrode configured to receive electric current through the welding-type tool, has made a first contact with a part at a first touch position; move, via the robot, the welding-type tool in a second direction, until the touch sensor detects that the welding-type tool or the welding electrode has made a second contact with the part at a second touch position; and identify an intermediate position to which to move the welding-type tool or the welding electrode before seeking a third contact with the part at a third touch position.

In some examples, the touch sensor is configured to detect when the welding electrode touches the part by detecting a short circuit. In some examples, the non-transitory computer readable medium further comprises machine readable instructions which, when executed by a processor, cause the processor to move, via the robot, the welding-type tool or the welding electrode in an intermediate direction for an intermediate distance to the intermediate position. In some examples, the non-transitory computer readable medium further comprises machine readable instructions which, when executed by a processor, cause the processor to move, via the robot, the welding-type tool or the welding electrode from the first touch position to a first end position; move, via the robot, the welding-type tool or the welding electrode from the second touch position to a second end position; and move, via the robot, the welding-type tool or the welding electrode from the second end position to the intermediate position.

In some examples, the non-transitory computer readable medium further comprises machine readable instructions which, when executed by a processor, cause the processor to move, via the robot, the welding-type tool in the first direction, from a first starting position, until the touch sensor detects the first contact at the first touch position; move, via the robot, the welding-type tool in the second direction, from a second starting position, until the touch sensor detects the second contact at the second touch position; and move, via the robot, the welding-type tool or the welding electrode from the intermediate position to a third starting position. In some examples, the non-transitory computer readable medium further comprises machine readable instructions which, when executed by a processor, cause the processor to move, via the robot, the welding-type tool or the welding electrode in a third direction, from the third starting position, until the touch sensor detects that the welding-type tool or the welding electrode has made a third contact with the part at a third touch position. In some examples, the third direction is perpendicular to the first direction and the second direction.

In some examples, the non-transitory computer readable medium further comprises machine readable instructions which, when executed by a processor, cause the processor to identify a welding position based on the first touch position, the second touch position, and the third touch position; and perform a welding-type operation at the welding position using the welding-type tool or the welding electrode. In some examples, the non-transitory computer readable medium further comprises machine readable instructions which, when executed by a processor, cause the processor to identify the intermediate direction based on the first direction and the second direction; and identify the intermediate position based on the intermediate direction and the third starting position. In some examples, the intermediate direction is perpendicular to the first direction and the second direction, and the intermediate position and the third starting position are both located in an intermediate plane that is perpendicular to the intermediate direction.

Some examples of the present disclosure relate to a robotic welding system, comprising a welding-type tool configured to route electric current to a welding electrode; a robot configured to manipulate the welding-type tool; a touch sensor configured to detect when the welding-type tool or the welding electrode touches a part; and processing circuitry configured to: move, via the robot, the welding-type tool in a first direction, until the touch sensor detects that the welding-type tool or the welding electrode has made a first contact with the part at a first touch position, move, via the robot, the welding-type tool in a second direction, until the touch sensor detects that the welding-type tool or the welding electrode has made a second contact with the part at a second touch position, and identify an intermediate position to which to move the welding-type tool or the welding electrode before seeking a third contact with the part at a third touch position.

In some examples, the touch sensor is configured to detect when the welding electrode touches the part by detecting a short circuit. In some examples, the processing circuitry is further configured to move, via the robot, the welding-type tool or the welding electrode in an intermediate direction for an intermediate distance to the intermediate position. In some examples, the processing circuitry is configured to: move, via the robot, the welding-type tool or the welding electrode from the first touch position to a first end position, move, via the robot, the welding-type tool or the welding electrode from the second touch position to a second end position, and move, via the robot, the welding-type tool or the welding electrode from the second end position to the intermediate position.

In some examples, the processing circuitry is configured to: move, via the robot, the welding-type tool in the first direction, from a first starting position, until the touch sensor detects the first contact at the first touch position, move, via the robot, the welding-type type tool in the second direction, from a second starting position, until the touch sensor detects the second contact at the second touch position, and move, via the robot, the welding-type tool or the welding electrode from the intermediate position to a third starting position. In some examples, the processing circuitry is further configured to move, via the robot, the welding-type tool or the welding electrode in a third direction, from the third starting position, until the touch sensor detects that the welding-type tool or the welding electrode has made a third contact with the part at a third touch position.

In some examples, the third direction is perpendicular to the first direction and the second direction. In some examples, the processing circuitry is further configured to: identify a welding position based on the first touch position, the second touch position, and the third touch position, and perform a welding-type operation at the welding position using the welding-type tool or the welding electrode. In some examples, the processing circuitry is configured to: identify the intermediate direction based on the first direction and the second direction, and identify the intermediate position based on the intermediate direction and the third starting position. In some examples, the intermediate direction is perpendicular to the first direction and the second direction, and the intermediate position and the third starting position are both located in an intermediate plane that is perpendicular to the intermediate direction.

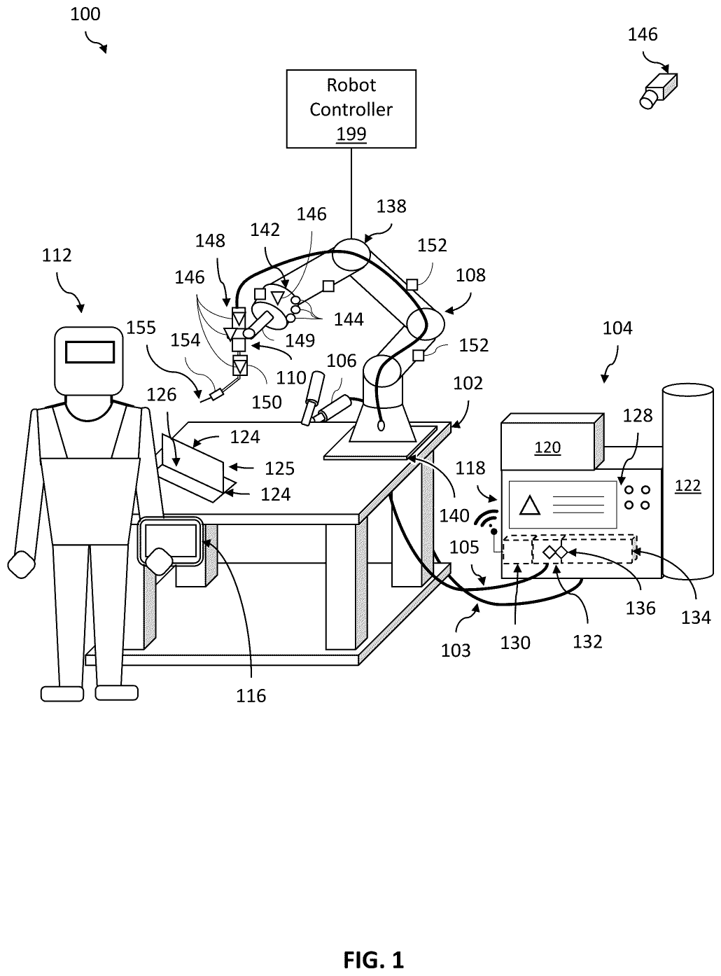

FIG. 1 illustrates an example robotic welding system 100 configured to perform welding-type operations. As shown, the robotic welding system 100 includes a welding table 102, welding equipment 104 connected to the welding table 102 via a ground cable 103 and clamp 106, and a robot 108 attached to the welding table 102. The robotic welding system 100 further includes a robot controller 199 configured to control the robot 108, and a welding-type tool 110 attached to the robot 108 via bracket 149. The welding-type tool 110 is further shown connected to the welding equipment 104 via a weld cable 105.

Also shown in FIG. 1 is a welding operator 112. As shown, the welding operator 112 is holding a pendant 116. In some examples, the pendant 116 may also be considered part of the robotic welding system 100. In some examples, the pendant 116 may be in communication with the robot controller 199 and/or welding equipment 104. In some examples, the pendant 116 may serve as a user interface of the robot 108, robot controller 199, and/or the welding equipment 104.

In the example of FIG. 1, the welding-type equipment 104 comprises a welding-type power supply 118, wire feeder 120, and gas supply 122. In some examples, the wire feeder 120 may be configured to feed a welding wire to the welding-type tool 110 (e.g., via the weld cable 105). In some examples, the welding-type tool 110 may use wire fed from the wire feeder 120 as a welding electrode 155. In some examples, the gas supply 122 may be configured to route shielding gas to the welding-type tool 110 (e.g., via the weld cable 105).

In some examples, the welding-type power supply 118 may be configured to provide welding-type power to the welding-type tool 110 and/or clamp 106 via the weld cable 105 and/or ground cable 103. In some examples, the welding-type tool 110 may, in turn, provide the welding-type power to the welding electrode 155. When the welding-type power is of sufficient strength, and the welding electrode 155 and part 125 are in close enough proximity to one another, an electrical arc may be formed between the welding electrode 155 and part 125. While shown as coupled to the (e.g., electrically conductive) welding table 102 in the example of FIG. 1, in some examples, the clamp 106 may instead be coupled directly to one or more workpieces 124 of a part 125 supported by the welding table 102, or a different (e.g., electrically conductive) surface.

In the example of FIG. 1 the part 125 is shown as being made up of two workpieces 124 abutting one another at a joint 126. While only two workpieces 124 are shown as making up the part 125 in the example of FIG. 1, in some examples the part 125 may be made up of three or more workpieces 124. While only one part 125 is shown on the welding table 102 in the example of FIG. 1, in some examples, multiple parts 125 may be on the welding table 102.

In the example of FIG. 1, the welding-type power supply 118 includes an operator interface 128. In the example of FIG. 1, the operator interface 128 comprises one or more input devices (e.g., knobs, buttons, dials, switches, keys, touchscreens, microphones, etc.) and/or output devices (e.g., display screens, lights, speakers, etc.). While shown as part of the welding-type power supply 118 in the example of FIG. 1, in some examples, the operator interface 128 (or a different operator interface) may be part of the wire feeder 120 and/or gas supply 122.

In some examples, the operator interface 128 may be implemented via the pendant 116 and/or or some other remote control device. In some examples, the operator 112 (and/or other user) may use the input device(s) of the operator interface 128 to select one or more target and/or actual welding parameters (e.g., voltage, current, gas type, gas flow rate, wire feed speed, workpiece material type, filler type, wire diameter, welding-type process, etc.). In some examples, the operator 112 (and/or other user) may use the output device(s) of the operator interface 128 to learn of certain information regarding the welding-type equipment 104 and/or welding-type operation.

In the example of FIG. 1, the welding-type power supply 118 also includes power communication circuitry 130, power control circuitry 132, and power conversion circuitry 134 interconnected with one another. While not shown for the sake of simplicity and clarity, in some examples, the operator interface 128 may also be connected with the power control circuitry 132 and/or power communication circuitry 130.

In some examples, the power communication circuitry 130 may be configured for communication with the pendant 116, robot 108, and/or robot controller 199. In some examples, the communication may take the form of wireless communication and/or wired communication (e.g., via a welding cable). While shown as part of the welding-type power supply 118 in the example of FIG. 1, in some examples, the power communication circuitry 130 (or additional communication circuitry) may be part of the wire feeder 120 and/or gas supply 122.

In some examples, the power conversion circuitry 134 may be configured to receive input power (e.g., from a generator, a battery, mains power, etc.) and convert the input power to welding-type output power, such as might be suitable for use by the welding- type tool 110 for welding-type operations, for example. In some examples, the power conversion circuitry 132 may include circuit elements (e.g., transformers, rectifiers, capacitors, inductors, diodes, transistors, switches, and so forth) capable of converting the input power to output power. In some examples, the power conversion circuitry 132 may also include one or more controllable circuit elements (e.g., switches, relays, transistors, etc.) configured to change states (e.g., fire, turn on/off, close/open, etc.) based on one or more control signals. In some examples, the state(s) of the controllable circuit elements may impact the operation of the power conversion circuitry 132, and/or impact characteristics (e.g., current/voltage magnitude, frequency, waveform, etc.) of the output power provided by the power conversion circuitry 132.

In some examples, the power control circuitry 132 may be configured to control operation of the power communication circuitry 130, power conversion circuitry 134, wire feeder 120, and/or gas supply 122 (e.g. via one or more control signals). For example, the power control circuitry 132 may control the power conversion circuitry 134 via one or more control signals delivered to the controllable circuit elements of the power conversion circuitry 134. In some examples, the power control circuitry 132 may control the power communication circuitry 130, power conversion circuitry 134, wire feeder 120, and/or gas supply 122 based on one or more welding parameters (e.g., input via the operator interface 128 and/or received from the robot controller 199 and/or pendant 116). In some examples, the power control circuitry 132 may include processing circuitry and/or memory circuitry. While shown as part of the welding-type power supply 118 in the example of FIG. 1, in some examples, the power control circuitry 132 (and/or other control circuitry) may be part of the wire feeder 120 or gas supply 122.

In the example of FIG. 1, the welding-type power supply 118 also includes electrical sensors 136. As shown, the electrical sensors 136 are connected to the power control circuitry 132 and power conversion circuitry 134. In some examples, the electrical sensor(s) 136 may comprise one or more current sensors 136 that detects an electrical current of (and/or output by) the power conversion circuitry 134 and/or welding-type power supply 118.

For example, the current sensor(s) 136 may detect a magnitude, phase, frequency, and/or polarity of electrical current sent by the welding-type power supply 118 (e.g., via the power conversion circuitry 134) to the welding-type tool 110 and/or clamp 106 (e.g., via the weld cable 105 and/or ground cable 103). As another example, the current sensor(s) 136 may detect a current that is negligible and/or approximately zero (e.g., within 0.1 milliamps) when there is an open circuit between the electrode 155 (and/or welding-type tool 110) and the part 125 (and/or welding table 102, clamp 106, etc.). In some examples, such an open circuit may occur when there is no welding arc or contact between the electrode 155 (and/or welding-type tool 110) and the part 125 (and/or welding table 102, clamp 106, etc.).

As another example, the current sensor 136 may detect a current that is non-negligible and/or non-zero (e.g., beyond 0.1 milliamps) when there is a closed and/or short circuit between the electrode 155 (and/or welding-type tool 110) and the part 125 (and/or welding table 102, clamp 106, etc.). In some examples, such a closed and/or short circuit may occur when there is a welding arc or contact between the electrode 155 (and/or welding-type tool 110) and the part 125 (and/or welding table 102, clamp 106, etc.).

In some examples, the electrical sensor(s) 136 may comprise one or more voltage sensors 136 that detect a voltage drop across the outputs (e.g., weld cable 105 and ground cable 103) of the power conversion circuitry 134 and/or welding-type power supply 118. As the outputs of the welding-type power supply 118 are electrically connected on one end to the welding-type tool 110 and/or welding electrode 155 (e.g., via the weld cable 105) and at the other end to the welding table 102 and/or part 125 (e.g., via the ground cable 103), in some examples, the voltage sensor(s) 136 might detect the voltage difference between welding electrode 155 (or welding-type tool 110) and the part 125 (or welding table 102).

For example, the voltage sensor(s) 136 might detect a voltage drop/difference that is negligible (e.g., less than 1 volt) and/or approximately zero (e.g., within 2 millivolts) when there is a short circuit. Such a short circuit may occur when there is contact between the electrode 155 (and/or welding-type tool 110) and the part 125 (and/or welding table 102, clamp 106, etc.). As another example, the voltage sensor(s) 136 might detect a non-negligible and/or non-zero voltage when there is an open circuit and/or welding arc.

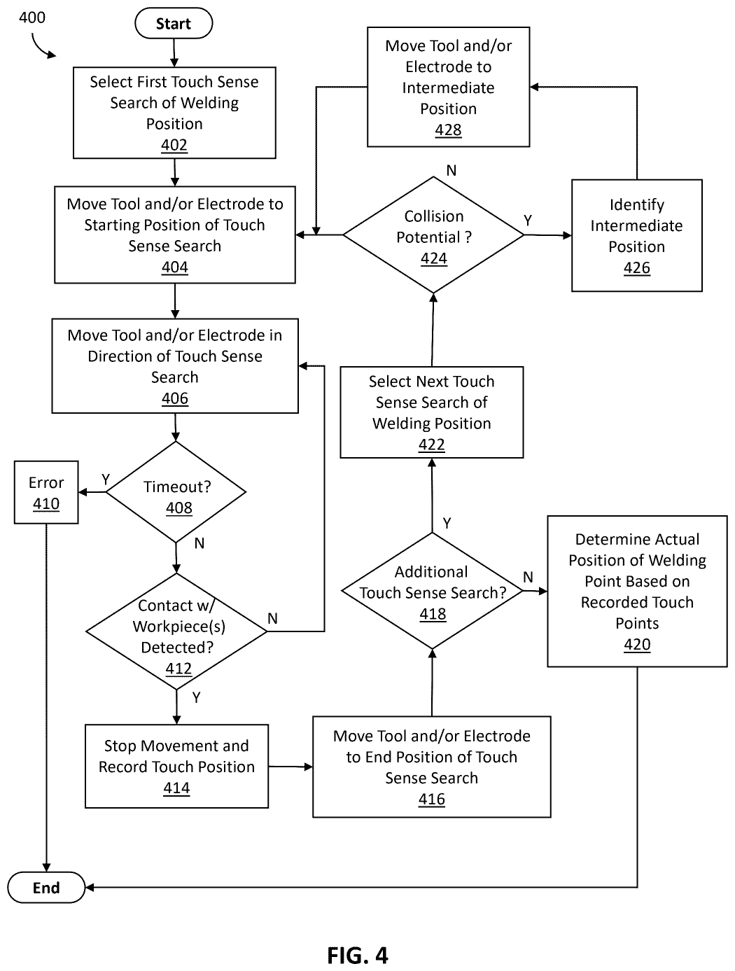

While shown as part of the welding-type power supply 118 in the example of FIG. 1, in some examples, the electrical sensor(s) 136 may be part of the weld cable 105, the ground cable 103, the clamp 106, and/or the welding-type tool 110. In some examples, the measurements of the electrical sensor 136 may be used to determine when contact is made between the welding electrode 155 and the part 125, such as during a touch sense process 400 (e.g., as described below with respect to FIG. 4).

In the example of FIG. 1, the robot 108 comprises a robotic arm 138 with several segments interconnected by joints that allow the robotic arm 138 to move in several degrees of freedom. For example, each joint may have one or more degrees of freedom, to allow the robotic arm 138 to achieve multiple orientations for accessing one or more weld joints on a part 125. In some examples, the robotic arm 138 may instead comprise a different type of robotic manipulator, and/or the robot 108 may include an additional robotic manipulator. As shown, the robotic arm 138 is secured to the table 102 via a base 140.

In some examples, the robot 108 may be configured as a collaborative robot, or cobot. Whereas conventional welding robots may be confined within a cage or otherwise contained within a weld cell that is protected against intrusion (e.g., by operators) during robot operations (e.g., welding operations and/or other movement by the robot), cobots may instead be configured to operate in a manner such that humans do not necessarily need to be excluded from the area in which the robot 108 is operating. For example, the robot 108 may rapidly detect and/or respond to collisions, may operate with reduced speed and/or joint torque relative to conventional welding robots, and/or implement other features designed to facilitate close collaboration between robot 108 and human operator 112.

In the example of FIG. 1, the robot 108 includes (and/or is connected with) a robot controller 199. In some examples, the robot controller 199 may be configured to control robot operations of the robot 108. For example, the robotic arm 138 may include (and/or be connected to) several motors and/or actuators configured to move the robotic arm 138, and the robot controller 199 may control movement of the robotic arm 138 via control of these motors and/or actuators.

In the example of FIG. 1, the robot 108 further includes several position sensors 152. As shown, the position sensors 152 are attached to the robotic arm 138. While termed position sensors 152, in some examples, the position sensors 152 may be configured to detect both the position and/or the orientation of one or more of the segments of the robotic arm 138. In some examples, the position sensors 152 may be configured to detect the position and/or orientation of the welding-type tool 110 attached to the robotic arm 138.

In some examples, the robot controller 199 may use data detected by the position sensor(s) 152 to track the position and/or orientation of the robot 108 and/or welding-type tool 110, and/or guide robot operations of the robot 108. In some examples, the robot controller 199 may additionally, or alternatively, track the position and/or orientation of the robot 108 and/or welding-type tool 110 through an understanding of some default and/or initial position and/or orientation of the robot 108, and the impact of one or more particular articulations, manipulations, and/or movements of the robot 108 and/or robotic arm 138 (e.g., made since the robot 108 and/or robotic arm 138 was in the default and/or initial position and/or orientation).

In some examples, the robot 108 (and/or robot controller 199) may be in communication with the welding-type equipment 104 (e.g., via the power communication circuitry 130). In some examples, the communication may be wireless and/or wired. In some examples, electrical leads connected to the robot 108 and/or robot controller 199 may be spliced into the welding cable coupling the welding-type tool 110 to the welding-type equipment 104, such that wired communication between the robot 108 (and/or robot controller 199) and welding-type equipment 104 may occur via the welding cable. In some examples, a separate wired connection may be made between the robot 108 (and/or robot controller 199) and the welding-type equipment 104.

In some examples, the welding-type equipment 104 and robot 108 may communicate by way of one or more signals. In some examples, the robot 108 (and/or robot controller 199) may transmit and/or receive one or more commands, requests, responses, acknowledgements, data, and/or other messages to/from the welding-type equipment 104. In some examples, the robot 108 (and/or robot controller 199) may transmit one or more target welding parameters (e.g., target voltage, target current, target wire feed speed, target gas flow rate, target welding-type process, etc.) to the welding-type equipment 104. In some examples, the welding-type equipment 104 may configure, control, and/or adjust its operation based on and/or according to the welding parameters. In some examples, the welding-type equipment 104 may, in turn, transmit one or more actual/detected welding parameters (e.g., actual/detected voltage, current, wire feed speed, gas flow rate, welding-type process etc.).

In some examples, the robot 108 (and/or robot controller 199) may transmit a trigger (and/or activation) command to the welding-type equipment 104. In some examples, the welding-type equipment 104 may output welding-type power, wire, and/or shielding gas in response to the trigger command. In some examples, the welding-type equipment 104 may cease output of welding-type power, wire, and/or shielding gas in the absence of the trigger command, and/or in response to some other command (e.g., deactivate, disable, etc.).

In some examples, the robot controller 199 may send a trigger/activation command to the welding-type equipment 104 when the robotic arm 138 has manipulated the welding-type tool 110 into proper position for a welding-type operation, and the timing is right for the welding-type operation. In some examples, the robot 108 may be programmed with the proper positioning and/or timing information, and this may be stored in memory circuitry of the robot controller 199. In this way, the robot controller 199 may control the movement of the robot 108 and the activation/deactivation of the welding-type tool 110, welding-type equipment 104, and/or welding-type operations according to prior programming.

In some examples, the robot 108 may be programmed via the pendant 116. In some examples, the pendant may be in (e.g., wired and/or wireless) communication with the robot 108 and/or robot controller 199, through which programmatic information may be transmitted to the robot 108 and/or robot controller 199. In some examples, the pendant 116 may include one or more input mechanisms (e.g., knobs, buttons, touch screens, sliders, dials, microphones, keyboards, pointers, etc.) and/or output mechanisms (e.g., lights, display screens, speakers, haptic devices, etc.) through which the operator 112 can provide input to the robot 108 (and/or welding-type equipment) and/or perceive data related to operation of the robot (and/or welding-type equipment 104).

In some examples, the robot 108 may be programmed more directly. For example, the robot 108 may be configured so that the operator 112 may be able to physically grab and move the robotic arm 138 to a particular position and/or orientation. Thereafter, the operator 112 may provide an input to the robot 108 to “teach” or program the robot 108 to remember that position/orientation as part of an upcoming welding-type operation.

In the example of FIG. 1, the end of the robotic arm 138 (opposite the base 140) includes (and/or attaches to) a robotic interface 142. In some examples, the robotic interface 142 may be attached to (and/or extend from) a wrist of the robotic arm 138. As shown the robotic interface 142 includes input/output (I/O) devices 144 (e.g., knobs, buttons, touch screens, sliders, dials, microphones, keyboards, pointers, lights, display screens, speakers, etc.) configured to allow the operator 112 to provide direct input to, and/or receive output from, the robot 108. In some examples, the I/O devices 144 may be in electrical communication with the robot controller 199.

In some examples, the operator 112 may use the I/O devices 144 to tell the robot controller 199 to put the robot 108 into a movable (e.g., low torque) mode so that the operator can manually (e.g., by hand) move the robotic arm 138 around to a desired position. In some examples, the operator 112 may use the I/O devices 144 to program the robot 108, such as, for example, providing an input to indicate to the robot controller 199 that the current position/orientation of the robot 108 should be remembered for a future welding-type operation. In some examples, the operator 112 may use the I/O devices 144 to manually activate the welding-type tool 110 (e.g., by sending an appropriate signal to the welding-type equipment 104).

In the example of FIG. 1, the robotic welding system 100 also includes several operation sensors 146 configured to direct one or more operational parameters. As shown, the operation sensors 146 are attached to (and/or retained by) the robotic interface 142, the bracket 149 connecting the robotic interface 142 to the welding-type tool 110, a handle 148 of the welding-type tool 110, and a sleeve 150 that covers (and/or is attached to and/or retained by) a neck of the welding-type tool. Another operation sensor 146 is shown unattached to the robot 108.

In some examples, the operation sensors 146 may detect various environmental and/or operational information via acoustic, thermal, ultrasonic, infrared, electromagnetic, sonar, and/or other means. In some examples, one or more of the operation sensors 146 may be camera and/or optical sensors configured to capture images that may be analyzed (e.g., using various computer vision techniques) to determine position/orientation of the robot 108 and/or various environmental and/or operational information. In some examples, one or more of the operation sensors 146 may use short range communication devices, such as, for example, radio frequency identification (RFID), near field communication (NFC), and/or Bluetooth devices. In some examples, one or more of the operation sensors 146 may comprise range finding sensors, proximity sensors, and/or pressure sensors.

While depicted in the example of FIG. 1 as having a handle 148, neck, nozzle assembly 154, and electrode, in some examples, the components (and/or component arrangements) of the welding-type tool 110 may depend upon the particular type of welding-type tool 110. In some examples, the welding-type tool 110 may be a welding torch or gun configured for gas metal arc welding (GMAW). In some examples, the welding-type tool 110 may be an electrode holder (i.e., stinger) configured for shielded metal arc welding (SMAW). In some examples, the welding-type tool 110 may be a torch and/or filler rod configured for gas tungsten arc welding (GTAW). In some examples, the welding-type tool 110 may be a welding gun configured for flux-cored arc welding (FCAW). In some examples, the welding-type tool 110 may be a plasma cutter.

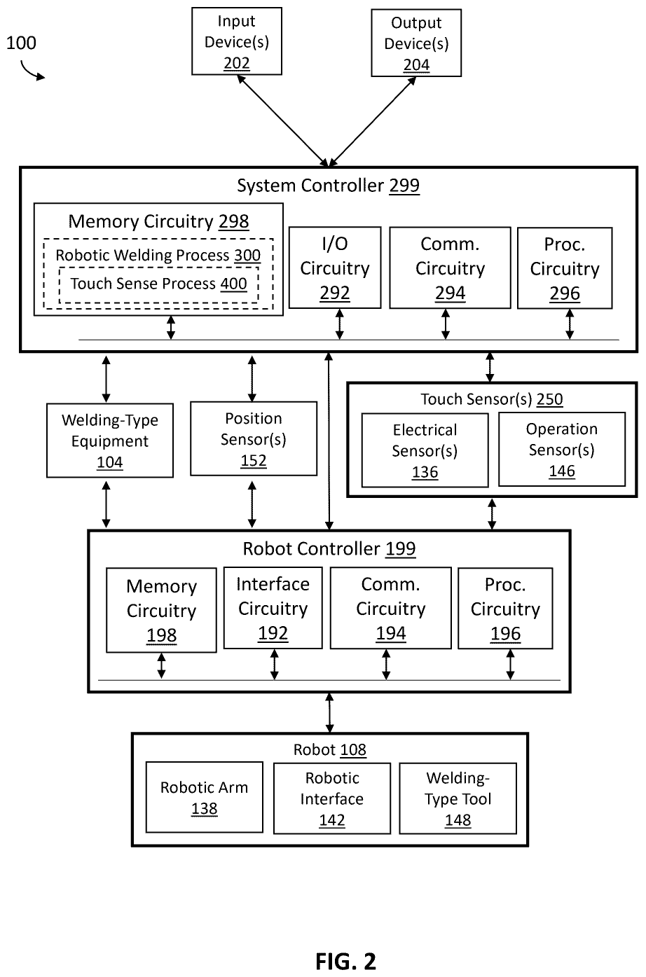

FIG. 2 is a block diagram showing additional components and/or connections of the robotic welding system 100. For example, FIG. 2 shows the robotic welding system additionally includes a system controller 299. While shown as its own separate and/or distinct component for purposes of explanation and understanding, in some examples, the system controller 299 may be implemented via the pendant 116, robot controller 199, and/or welding-type equipment 104 (e.g., welding-type power supply 118).

In the example of FIG. 2, the system controller 299 is shown connected and/or in communication with one or more input devices 202 and one or more output devices 204. In some examples, the operator 112 may provide input to the system controller 299 via the input device(s) 202. In some examples, the input devices 202 may include one or more knobs, buttons, touch screens, sliders, dials, microphones, keyboards, pointers, and/or other appropriate devices. In some examples, the operator 112 may perceive information output by the system controller 299 via the output devices 204. In some examples, the output devices 204 may include one or more lights, display screens, speakers, haptic devices, and/or other appropriate devices.

In some examples, the input devices 202 and/or output devices 204 may be implemented via the operator interface 128 of the welding-type equipment 104, the pendant 116, the I/O devices 144 of the robotic interface 142, and/or the tool sleeve 150. In some examples, the input devices and/or output devices 204 may be part of, attached to, and/or retained by the welding table 102.

In the example of FIG. 2, the system controller 299 is further shown connected and/or in communication with the welding-type equipment 104, the position sensors 152, and the robot controller 199. In the example of FIG. 2, the robot controller 199 includes robot memory circuitry 198, robot processing circuitry 196, robot communication circuitry 194, and interface circuitry 192 interconnected with one another via a common electrical bus. In some examples, the interface circuitry 192 may comprise one or more drivers for the robotic interface 142 and/or I/O devices 144. In some examples, the interface circuitry 192 may be configured to generate one or more signals representative of input received via the robotic interface 142 (and/or I/O devices 144), and provide the signal(s) to the bus. In some examples, the interface circuitry 192 may also be configured to control the robotic interface 142 (and/or I/O devices 144), to generate one or more outputs in response to one or more signals (e.g., received via the bus).

In some examples, the robot communication circuitry 194 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, and/or cable ports. In some examples, the robot communication circuitry 194 may be configured to facilitate communication via one or more wired mediums (e.g., Ethernet cable(s), universal serial bus cable(s), etc.) and/or protocols and/or wireless mediums and/or protocols (e.g., cellular communication, long term evolution (LTE), NFC, RFID, general packet radio service (GPRS), IEEE 802.11, and/or ultra high frequency radio wave (commonly known as Bluetooth) protocols). In some examples, the robot communication circuitry 194 may be coupled to one or more antennas to facilitate wireless communication.

In some examples, the robot communication circuitry 194 may be configured to facilitate communications of the robot controller 199. In some examples, the robot communication circuitry 194 may receive one or more signals (e.g., from the system controller 299, welding-type equipment 104, etc.) decode the signal(s), and provide the decoded data to the electrical bus. As another example, the robot communication circuitry 194 may receive one or more signals from the electrical bus (e.g., representative of one or more inputs received via the interface circuitry 192 and/or robotic interface 142) encode the signal(s), and transmit the encoded signal(s) to an external device (e.g., system controller 299, welding-type equipment 104, etc.).

In some examples, the robot processing circuitry 196 may comprise one or more processors. In some examples, the robot processing circuitry 196 may comprise one or more drivers for the operation sensors 146 and/or position sensors 152. In some examples, the robot processing circuitry 196 may be configured to execute machine readable instructions stored in the robot memory circuitry 198.

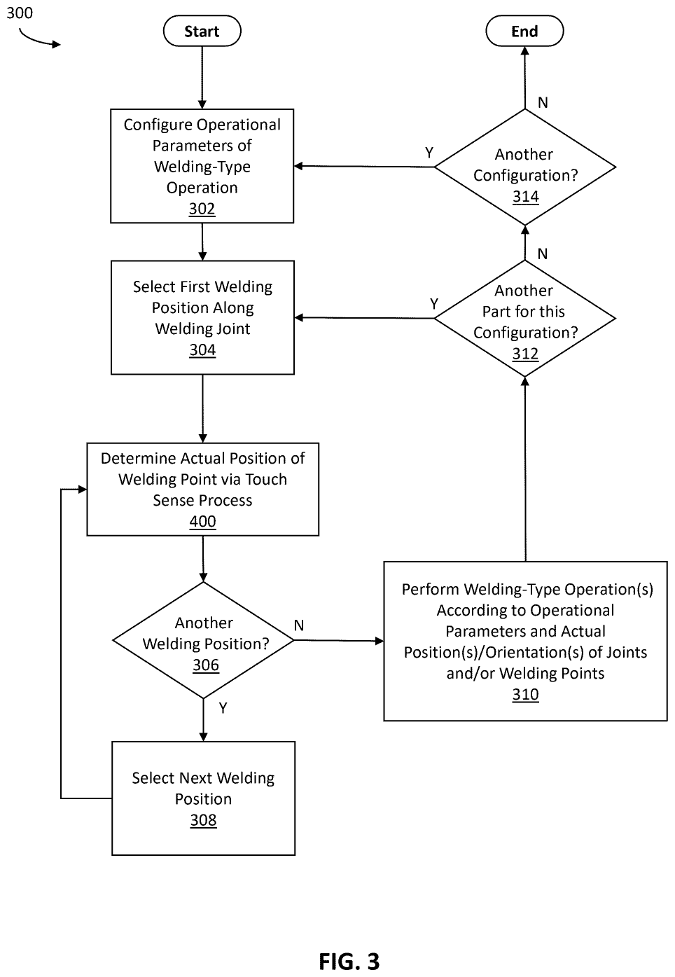

In the example of FIG. 2, both the robot controller 199 and the system controller 299 are shown connected to and/or in communication with one or more touch sensors 250. In some examples, the touch sensors 250 may be configured to detect contact (and/or a touch) between the welding electrode 155 (or welding-type tool 110) and the part 125. As shown, one or more electrical sensors 136 and/or operation sensors 146 may be used as the touch sensor(s) 250. In some examples, the system controller 299 may use the detections of the touch sensor(s) 250 during a touch sense process 400 of a robotic welding process 300 (see, e.g., FIGS. 3-4).

In the example of FIG. 2, the system controller 299 includes system memory circuitry 298, system processing circuitry 296, system communication circuitry 294, and system I/O circuitry 292 interconnected with one another via a common electrical bus. In some examples, the system I/O circuitry 292 may comprise one or more drivers for the input device(s) 202 and/or output device(s) 204. In some examples, the system I/O circuitry 292 may be configured to generate one or more signals representative of input received via input device(s) 202, and provide the signal(s) to the bus. In some examples, the system I/O circuitry 292 may also be configured to control the output device(s) 204 to generate one or more outputs in response to one or more signals (e.g., received via the bus).

In some examples, the system communication circuitry 294 may include one or more wireless adapters, wireless cards, cable adapters, wire adapters, dongles, radio frequency (RF) devices, wireless communication devices, Bluetooth devices, IEEE 802.11-compliant devices, WiFi devices, cellular devices, GPS devices, Ethernet ports, network ports, lightning cable ports, and/or cable ports. In some examples, the system communication circuitry 294 may be configured to facilitate communication via one or more wired mediums (e.g., Ethernet cable(s), universal serial bus cable(s), etc.) and/or protocols and/or wireless mediums and/or protocols (e.g., cellular communication, long term evolution (LTE), NFC, RFID, general packet radio service (GPRS), IEEE 802.11, and/or ultra high frequency radio wave (commonly known as Bluetooth) protocols). In some examples, the system communication circuitry 294 may be coupled to one or more antennas to facilitate wireless communication.

In some examples, the system communication circuitry 294 may be configured to facilitate communications of the system controller 299. In some examples, the system communication circuitry 294 may receive one or more signals (e.g., from the robot controller 199, welding-type equipment 104, etc.) decode the signal(s), and provide the decoded data to the electrical bus. As another example, the system communication circuitry 294 may receive one or more signals from the electrical bus (e.g., representative of one or more inputs received via the system I/O circuitry 292 and/or input device(s) 202) encode the signal(s), and transmit the encoded signal(s) to an external device (e.g., the robot controller 199, welding-type equipment 104, etc.).

In some examples, the system processing circuitry 296 may comprise one or more processors, controllers, and/or graphical processing units (GPUs). In some examples, the system processing circuitry 296 may comprise one or more drivers for the operation sensors 146, position sensors 152, and/or current/voltage sensor(s) 136. In some examples, the system processing circuitry 296 may be configured to execute machine readable instructions stored in the system memory circuitry 298.

In the example of FIG. 2, the system memory circuitry 298 includes (and/or stores) a robotic welding process 300. As shown, the robotic welding process 300 includes a touch sense process 400. In some examples, the robotic welding process 300 and/or touch sense process 400 may comprise machine readable instructions configured for execution by the system processing circuitry 296. In some examples, the system memory circuitry 298 may further include (and/or store) certain parameters and/or thresholds used in the robotic welding process 300 and/or touch sense process 400. In some examples, the parameters and/or thresholds may also be considered part of the robotic welding process 300 and/or touch sense process 400

In some examples, the robotic welding process 300 may comprise a process by which the robot 108 performs a welding-type operation on the part 125 using the welding-type tool 110 (e.g., as manipulated by the robotic arm 138). In some examples, the robotic welding process 300 may be configured to repeatedly perform the same (or similar) welding-type operations on a succession of similar parts 125 and/or workpieces 124 according to some user and/or programmatically defined operational parameters (e.g., saved in system memory circuitry 298). However, the welding-type operation may be (at least slightly) recalibrated each time to account for (sometimes minor) variations in the placement of the part 125 and/or workpieces 124 (e.g., on the welding table 102).

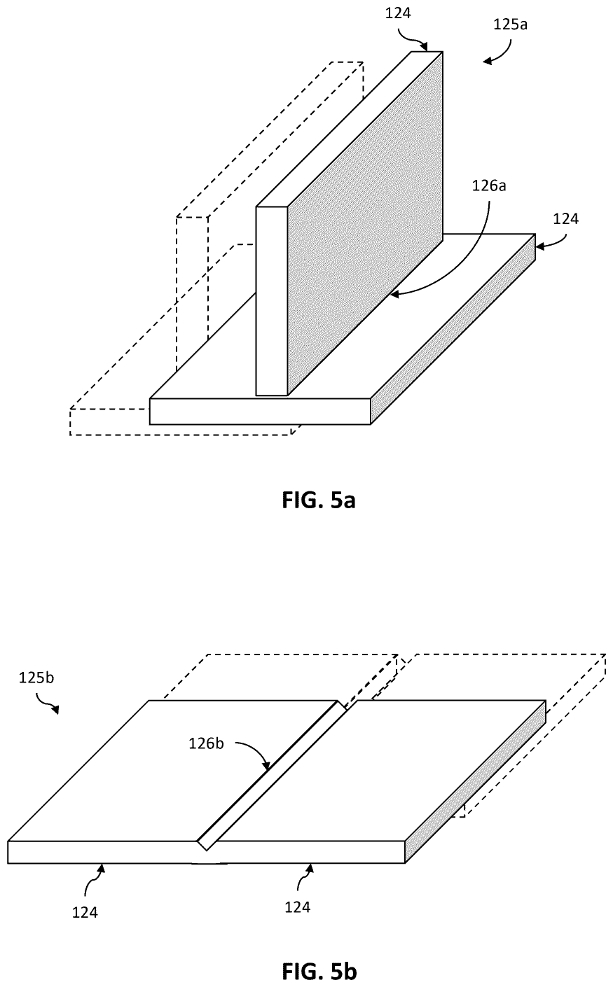

FIGS. 5a-5b show examples of how an actual position of a part 125 might be different than and/or offset from an expected, programmed, and/or previously defined position. In the example of FIGS. 5a-5b, the expected, programmed, and/or previously defined position of the part 125 is shown in dotted/dashed lines. In some examples, such a position may be defined by a user when setting up and/or configuring operational parameters for a welding-type operation that might be performed via the robotic welding process 300. In contrast, the actual position of the part 125 is shown in solid lines. In some examples, the part 125 may be so positioned (e.g., on the welding table 102) using one or more fixtures, guides, and/or other devices. While the fixtures, guides, and/or other devices may be configured to secure the part 125 as close as possible to the expected, programmed, and/or previously defined position, (e.g., minor) variations in position may nevertheless inevitably occur.

In some examples, the touch sense process 400 is used to account for the inevitable variations and/or discrepancies between the expected, programmed, and/or previously defined position of the part 125, and the actual position of the part 125. In particular, the touch sense process 400 determines the actual position of the part 125 by moving the welding-type tool 110 and/or electrode 155 until the welding-type tool 110 and/or electrode 155 touches (and/or makes contact with) the part 125. The system 100 can detect when contact between the part and the electrode 155 (and/or welding-type tool 110) occurs using the touch sensor(s) 250. The system 100 can also track the position/orientation of the welding-type tool 110 and/or electrode 155 (e.g., using the position sensor(s) 152). Thus, the touch sense process 400 can identify an actual position of the part 125 (at least in some respect) by identifying the position of the welding-type tool 110 and/or electrode 155 when the welding-type tool 110 and/or electrode 155 touches the part 125.

The present disclosure improves upon the touch sense process 400 by identifying an intermediate position 610 to which to move the welding-type tool 110 and/or electrode 155 between certain touches. For example, the touch sense process 400 might use the intermediate position 610 after completion of a penultimate touch, and/or before beginning a final touch, where three or more touches are used to identify a welding position 602. The disclosed improved touch sense process 400 moves the welding-type tool 110 and/or electrode 155 to the intermediate position 610 to avoid potential accidental and/or unintentional contact with the part 125, which might detrimentally impact the robotic welding process 300.

FIG. 3 is a flowchart illustrating example operation of the robotic welding process 300. While the robotic welding process 300 and/or touch sense process 400 is sometimes described below as conducting certain actions for the sake of understanding, it should be understood that one or more of the above described components of the robotic welding system 100 (e.g., the system processing circuitry 296, input devices 202, output devices 204, robotic arm 138, etc.) may undertake the actions on behalf (and/or according to instructions) of the robotic welding process 300 and/or touch sense process 400.

In the example of FIG. 3, the robotic welding process 300 begins at block 302, where a robotic welding-type operation is configured. In some examples, configuration of the robotic welding-type operation may involve configuration of certain operational parameters governing how the robotic welding-type operation will be conducted. In some examples, the operator 112 may enter all or some of the operational parameters (e.g., via the pendant 116, operator interface 128, and/or input device(s) 202). In some examples, some or all of the operational parameters may be stored (and/or have been previously stored) in system memory circuitry 298 and/or be loaded from system memory circuitry 298 at block 302.

In some examples, the operational parameters may include technique parameters, such as, for example, work angle, travel angle, contact tip to work distance, aim, travel speed, etc. In some examples, the operational parameters may include welding parameters, such as, for example, voltage and/or current (e.g., of the welding-type output power), wire feed speed, gas flow rate, wire type, gas type, and/or welding-type process. In some examples, one or more of the welding parameters may be automatically determined by the welding-type equipment 104 (e.g., based on other operational parameters).

In some examples, the operational parameters may include information and/or parameters about the part 125 to be operated on (e.g., part parameters). In some examples, such part parameters may include, for example, the number of workpieces 124, the material type of each workpiece 124, and/or the type(s) of joint(s) 126 formed by the workpieces 124 (e.g., Tee, lap, corner, butt, edge, etc.).

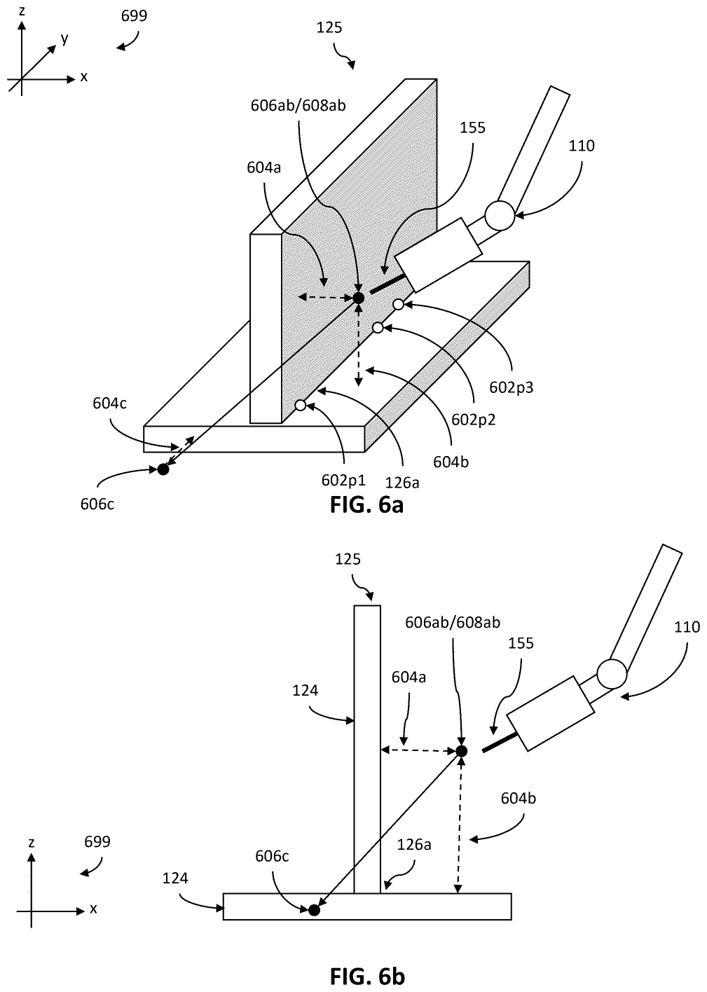

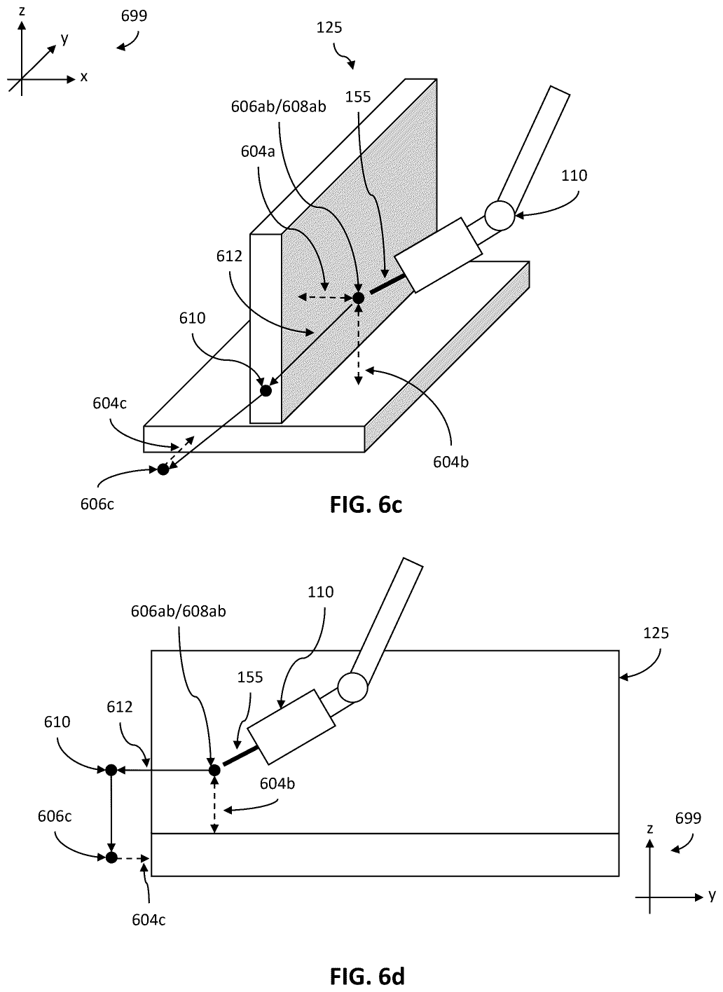

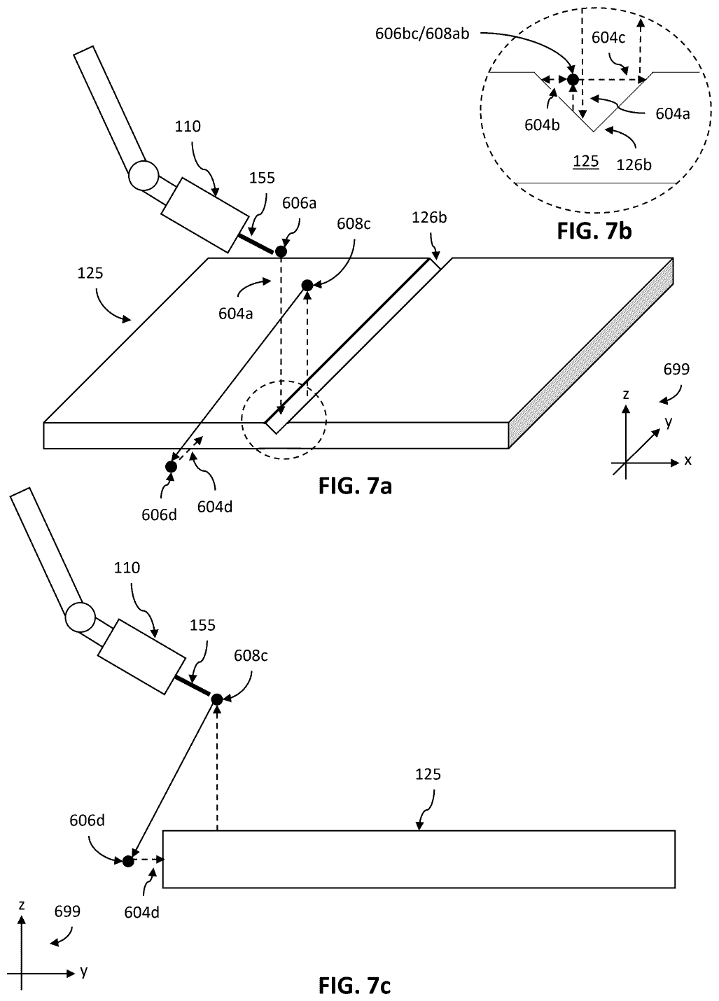

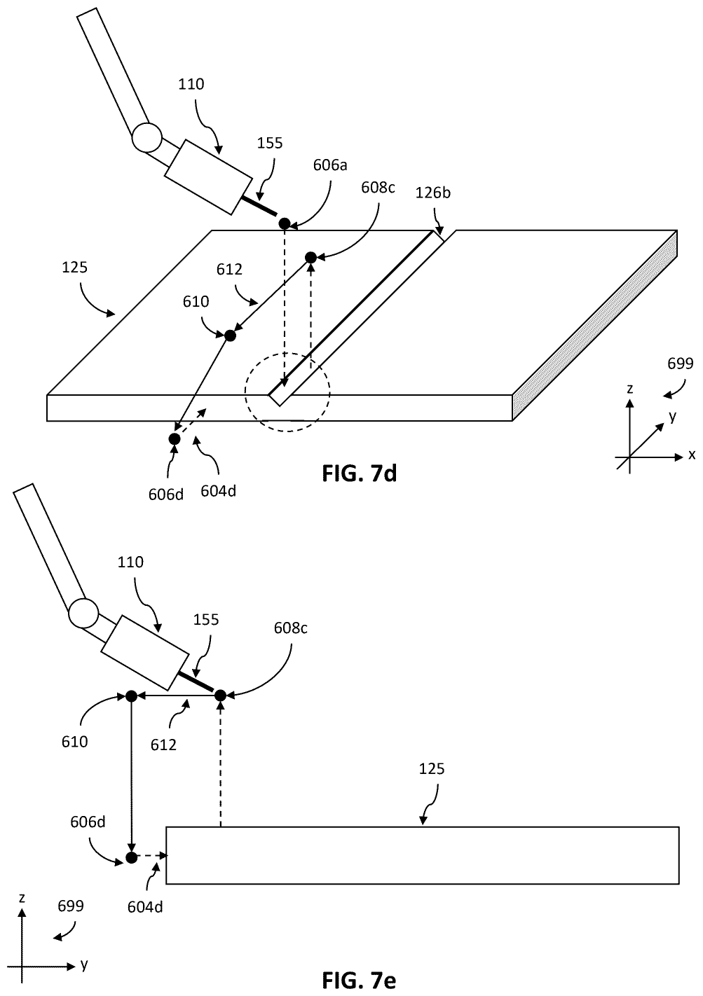

In some examples, the operational parameters may include information and/or parameters about the joint 126 (and/or seam, intersection of workpieces 124 to be operated upon, etc.). Joint parameters may include, for example, the type of joint(s) 126, the length of each joint 126, and/or the (e.g., expected) position(s) and/or orientation(s) of each joint 126. In some examples, the position(s) and/or orientations(s) of each joint 126 may be defined and/or represented by positions of two or more welding positions 602 along the joint 126 (see, e.g., FIG. 6a). In some examples, position information may be defined in a (e.g., x, y, z) coordinate system and/or reference frame 699 of the robot 108 and/or system 100 (see, e.g., FIGS. 6a-7e). In some examples, configuration of the joint parameter(s) may involve the operator 112 appropriately positioning/moving the robot 108 and/or welding-type tool 110 to “teach” the robot 108 and/or system 100 information (e.g., position(s)/orientation(s)) about the welding positions 602 and/or joint(s) 126.

In some examples, configuration of the robotic welding-type operation at block 302 may further involve configuration of certain touch sense parameters. In some examples, the touch sense parameters may be used in the touch sense process 400. In some examples the touch sense parameters may include, for example, number of touch sense searches (e.g., for each, all, and/or particular welding positions 602). In some examples, touch sense parameters may further include, a starting position 606 for each touch sense search, an end position 608 for each touch sense search, a search direction 604 for each touch sense search, and a search duration for each touch sense search (sec, e.g., FIGS. 6a-7e).

In the example of FIG. 3, after block 302, the robotic welding process 300 proceeds to block 304 where the robotic welding process 300 selects a first welding position 602 of the welding positions 602 defined in and/or by the operational parameters. In some examples, operational parameters may define an order of welding joints 126 and/or welding positions 602 for each welding joint 126, and the robotic welding process 300 may select the first of these welding positions 602 according to the defined order at block 304. In some examples, there may be no particular defined order, and block 304 may simply involve the robotic welding process 300 choosing a random welding position 602.

In the example of FIG. 3, after block 304, the robotic welding process 300 executes the touch sense process 400 with respect to the welding position 602 selected at block 304. As discussed above, the touch sense process 400 may detect and/or determine the actual position of a welding position 602, and/or an offset between the configured and actual position of a welding position 602. By determining the actual position of the welding positions 602 defining a joint 126, the touch sense process 400 determines the actual position and/or orientation of the joint 126 defined by the welding positions 602. The touch sense process 400 is discussed further below with respect to FIG. 4.

After the touch sense process 400, the robotic welding process 300 determines whether there is another welding position 602 defined by the operational parameters that has yet to be selected for that particular part 125. If so, the robotic welding process 300 proceeds to block 308 where the robotic welding process 300 selects the next welding position 602 of the welding positions 602 defined in and/or by the operational parameters. In examples where there is no particular defined order, block 308 may simply involve the robotic welding process 300 choosing a different welding position 602 than had been previously chosen at block 304 or block 308 for that particular part 125.

If the robotic welding process 300 determines that the touch sense process 400 has been executed with respect to all the welding positions 602, such that there are no more welding positions 602 to be selected, then the robotic welding process 300 proceeds to block 310 after block 306. At block 310, the robotic welding process 300 performs one or more welding-type operations on the part 125 (e.g., at/along the joint(s) 126 and/or welding positions 602). In some examples, the welding-type operation(s) at block 310 may be performed according to the operational parameters configured at block 302 and/or the actual position(s)/orientation(s) of the joint 126 and/or welding positions 602 determined during the touch sense process 400.

In the example of FIG. 3, the robotic welding process 300 may return to block 304 after block 310 if the robotic welding process 300 determines (at block 312) that another welding-type operation should be performed on a different part 125 according to the operational parameters configured at block 302. Otherwise, the robotic welding process 300 may return to block 302 if the robotic welding process 300 determines (at block 314) that a different configuration of operational parameters should be used to perform a welding-type operation on a part 125.

In some examples, the robotic welding process 300 may prompt the operator 112 to provide input regarding the determination(s) of blocks 312 and 314, and make the determination(s) based on the input received from the operator 112. In some examples, the robotic welding process 300 may make the determination(s) based on data detected by the operation sensor(s) 146. As shown, the robotic welding process 300 ends after block 314 if the robotic welding process 300 determines (at block 314) that no other configuration of operational parameters should be used to perform additional welding-type operations on a part 125.

FIG. 4 is a flowchart illustrating example operation of the touch sense process 400. As shown, the touch sense process 400 begins at block 402 where the touch sense process 400 selects a first touch sense search for the welding position 602 selected at block 304 or 308 of the robotic welding process 300. In some examples, the touch sense parameters (e.g., configured at block 302 of the robotic welding process 300) define several touch sense searches for each welding position 602. In some examples, the touch sense parameters may further define an order of the touch sense searches for each welding position 602. In some examples, no order may be defined, and the touch sense process 400 may impart an order either randomly or according to some set of (e.g., stored) considerations.

After selecting the touch sense search at block 402, the touch sense process 400 proceeds to block 404 where the touch sense process 400 moves the electrode 155 and/or welding-type tool to a starting position 606 of the touch sense search (e.g., as defined in the touch sense parameters). In some examples, the movement may be achieved via manipulation of the welding-type tool 110 by the robotic arm 138. In some examples, the touch sense process 400 may communicate with the robot controller 199 to achieve the movement.

After moving the electrode 155 and/or the welding-type tool 110 to the starting position at block 404, the touch sense process 400 then proceeds to block 406 where the touch sense process 400 moves the electrode 155 and/or the welding-type tool 110 in the appropriate search direction 604 of the touch sense search (e.g., as defined in the touch sense parameters). In some examples, the search direction 604 may be represented by a straight line vector. In some examples, the search direction 604 may be parallel to an axis of a reference frame 699 of the robot 108. In some examples, the touch sense process 400 may orient the welding-type tool 110 such that the electrode 155 will be first to make contact with the part 125 when traveling in the search direction. Again, the manipulation and/or movement may be achieved via the robotic arm 138 and/or through communication with the robot controller 199.

In the example of FIG. 4, the touch sense process 400 outputs an error at block 410 if the touch sense process 400 determines (at block 408) that the electrode 155 and/or the welding-type tool 110 have been moved in the search direction 604 for a threshold amount of time or distance without making contact with the part 125. After the error, the touch sense process 400 (and/or robotic welding process 300) ends.

If, however, contact between the part 125 and the electrode 155 (and/or the welding-type tool 110) is detected at block 412 (e.g., by the touch sensor(s) 250), the touch sense process 400 stops movement of the electrode 155 and/or the welding-type tool 110 at block 414. The touch sense process 400 then identifies and records (e.g., in system memory circuitry 298) the position of the electrode 155 and/or the welding-type tool 110 when contact was made as a position of the part 125 (and/or a touch position).

In some examples, the touch sense process 400 may continuously track the position and/or orientation of the electrode 155 and/or the welding-type tool 110 using the position sensor(s) 152 and/or other means, such as discussed above. The touch sense process 400 may thereby use this position/orientation tracking to identify the position of the electrode 155 and/or the welding-type tool 110 when contact was made as a position of the part 125. In some examples, the touch sense process 400 may control the wire feeder 120 to provide a known amount of stick-out of the electrode 155 from the welding-type tool 110 so that the touch sense process 400 can identify the position of the (e.g., end/tip of the) electrode 155 based on the tracked position/orientation of the welding-type tool 110.

After identification and/or recordal of the touch position at block 414, the touch sense process 400 proceeds to block 416 where the touch sense process 400 moves the electrode 155 and/or the welding-type tool 110 to an end position 608 of the touch sense search (e.g., as defined in the touch sense parameters). Again, the manipulation and/or movement may be achieved via the robotic arm 138 and/or through communication with the robot controller 199.

In the example of FIG. 4, after block 416, the touch sense process 400 determines whether an additional touch sense search should be performed for the selected welding position 602 at block 418. In some examples, the determination may be based on the touch sense parameters, and/or the previous touch sense searches conducted for the selected welding position 602. If not, at block 420, the touch sense process 400 uses the touch position(s) recorded at block 414 to determine the actual position of the selected welding position, and/or the offset from the expected welding position. As shown, the touch sense process 400 ends after block 420.

If the touch sense process 400 determines an additional touch sense search should be performed for the selected welding position 602 at block 418, the touch sense process 400 selects the next touch sense search at block 422. Afterwards, at block 424, the touch sense process 400 determines whether there is a potential for an accidental and/or unintentional collision with the part 125 when moving the electrode 155 and/or welding-type tool 110 from the end position 608 of the prior touch sense search to the starting position 606 for the newly selected touch sense search.

In some examples, the potential collision determination at block 424 may be based on the operational parameter(s), touch parameter(s), and/or previous touch sense searches conducted for the selected welding position 602 and/or other welding positions 602. For example, the touch sense process 400 may determine collision is unlikely if the prior touch sense end position is the same as, or within some saved threshold distance of, the new touch sense start position.

As another example, the touch sense process 400 may determine collision is likely if the new touch sense search starting position is a threshold distance away from the prior touch sense search end position, and not in a direction directly perpendicular or parallel to the prior touch sense search direction. As another example, the touch sense process 400 may determine collision is likely if the new touch sense search direction is perpendicular to the last two prior touch sense search directions. As another example, the touch sense process 400 may determine collision is likely if the new touch sense search is the third touch sense search for a welding position 602 of a Tee, lap, or corner joint 126, the fourth touch sense search for a welding position 602 of a butt joint 126, or the final touch sense search for a welding position 602 at the very beginning or very end of the joint 126.

If the touch sense process 400 determines collision is unlikely, the touch sense process 400 returns to block 404 where the touch sense process 400 moves the electrode 155 and/or the welding-type tool 110 to the starting position 606 of the newly selected touch sense search. However, if the touch sense process 400 determines collision is likely at block 424, the touch sense process 400 proceeds to block 426.

At block 426, the touch sense process 400 identifies an intermediate position 610 to move the electrode 155 and/or the welding-type tool 110 between touch sense searches. In some examples, identifying the intermediate position 610 may comprise identifying an intermediate direction 612 and/or intermediate distance. In some examples, the touch sense process 400 may determine the intermediate position 610 based on the new touch sense search starting position 606, the new touch sense search direction 604, the prior touch sense search direction(s) 604, and/or other factors.

In some examples, the intermediate position 610 may be determined to be a position that shares at least one axial component coordinate (e.g., in the x, y, or z axis) with the new starting position 606, and/or lies in the same plane as (and/or within some threshold distance of the) the plane of the new starting position 606, where that plane is perpendicular to the search direction of the new touch sense search. In some examples, the intermediate position 610 may be determined to be a position that shares at least one axial component coordinate (e.g., in the x, y, or z axis) with the end position 608 of the prior touch sense search (or is within some threshold distance of the axial component coordinate). In some examples, a vector (e.g., intermediate direction 612) extending between the prior touch sense search end position 608 and the intermediate position 610 may extend parallel to the search direction 604 of the new touch sense search, and/or perpendicular to two or more (or all) of the prior touch sense search directions 604.

In some examples, the touch sense process 400 may output a notification to the operator 112 representative of the collision potential determination at block 424. In some examples, the touch sense process 400 may output a notification to the operator 112 representative of the identified intermediate position 610 at block 426. In some examples, the operator 112 may be given an opportunity to confirm and/or revise the collision potential determination and/or identified intermediate position 610.

While the collision potential determination and intermediate position 610 identification of blocks 424 and 426 are shown as occurring between the touch sense movements of blocks 404-416 for the sake of explanation, in some examples, the collision potential and intermediate position 610 determinations of blocks 424 and 426 may occur prior to the actual touch sense movements of blocks 404-416. For example, the collision potential and intermediate position 610 determinations of blocks 424 and 426 may occur during the initial parameter configuration of block 302, and simply be implemented at blocks 424 and 426.

By moving to an intermediate position 610, the welding-type tool 110 and/or welding electrode 155 may increase the likelihood of avoiding unintentional contact with the part 125 when moving from the prior end position 608 to the new starting position 606. While an operator 112 may manually (e.g., by hand), move the welding-type tool 110 to an intermediate position 610 where the operator knows (and/or can see) no collision will occur, automatically identifying and/or moving the welding-type tool 110 to an intermediate position 610 saves the operator 112 time, and/or guards against the risk of human error and/or forgetfulness.

In the example of FIG. 4, the touch sense process 400 moves the welding electrode 155 and/or welding-type tool 110 to the intermediate position 610 at block 428. After block 428, the touch sense process 400 moves the welding electrode 155 and/or welding-type tool 110 to the new starting position at block 404, then repeats the touch sense search blocks 406-41600.

FIGS. 6a-7e show how movement of the welding electrode 155 and/or welding-type tool 110 directly to a new touch sense starting position 606 from a prior touch sense end position 608 may result in a unintentional contact with the part 125. FIG. 6a shows several example (e.g., actual) welding positions 602 along a Tee joint 126a. Welding position 602p1 is shown as being an approximately initial/beginning position of the Tee joint 126a. In some examples, three touch sense searches may be needed to precisely identify the welding position 602a (e.g., in all three x, y, z axes).

FIGS. 6a-6d show example search directions 604 for the three touch sense searches. As shown, the search directions 604 are all parallel to one of the x, y, z, axes of a reference frame 699. In some examples, the reference frame 699 may be a world reference frame that remains set and constant, or a reference frame of the robot 108 and/or welding-type tool 110 that moves as the robotic arm 138 and/or welding-type tool 110 moves. As shown, the three touch sense searches are intended to find the actual welding position 602p1 (and/or the appropriate offset).

In the example of FIGS. 6a-6d, the first two touch sense searches have the same starting positions 606a, 606b and end positions 608a, 608b (collectively labeled 606ab/608ab in FIGS. 6a-6d). Thus, there is unlikely to be any part 125 collision when moving the welding electrode 155 and/or welding-type tool 110 between the end position 608a of the first touch sense search and the starting position 606b of the second touch sense search. Additionally, the touch sense search directions 604a, 604b are directly opposite to the directions the welding electrode 155 and/or welding-type tool 110 must travel to get to end position 608ab after making contact with the part 125.

However, the third touch sense search starting position 606c is some distance away, with no shared axial (e.g., x, y, z) component position. Thus, the touch sense process 400 might determine that there is a potential for collision. And, indeed, FIG. 6b shows that direct movement of the welding electrode 155 and/or welding-type tool 110 from the end position 608ab to the starting position 606c would cause the welding electrode 155 and/or welding-type tool 110 to cross the planes of both the workpieces 124. FIGS. 6c-6d, in contrast show how movement of the welding electrode 155 and/or welding-type tool 110 to an intermediate position 610 prior to movement to the starting position 606c would avoid contact with the part 125.

FIGS. 7a-7e show a similar example with respect to a butt joint 126b. However, there are four (rather than three) touch sense searches, and/or touch sense search directions 604. Additionally, while the first end position 608a, the second starting position 606b, the second end position 608b, and the third starting position 606c all share the same position (collectively denoted in FIG. 7b as 606bc/608bc), the first starting position 606a, third end position 608c, and fourth starting position 606d are all distinct.

FIGS. 7a and 7c show that there would likely be a collision when moving to the fourth starting position 606d if no intermediate position 610 is used. While the path between the third end position 608c and the fourth starting position 606d is not show intersecting the part 125, the path comes close enough (e.g., relative to the size of the welding-type tool 110 and/or electrode 155) that collision would be likely. FIGS. 7d-7e show how such a collision could be avoided by using an intermediate position 610.

The improved touch sense process 400 of the present disclosure automatically identifies an intermediate position 610 to which to move the welding-type tool 110 and/or electrode 155 between certain touches. The improved touch sense process 400 additionally automatically moves the welding-type tool 110 and/or electrode 155 to the intermediate position 610 between certain touches. Use of an intermediate position 610 between certain touches may reduce the potential for accidental and/or unintentional contact with the part 125, which might move the part 125 (e.g., such that previously determined actual welding positions 602 are no longer valid), damage the part 125, damage the welding-type tool 110, cause false contact detection by the touch sensor(s) 250, and/or otherwise be detrimental to the robotic welding process 300. Automatic movement to the intermediate position 610 (e.g., rather than manual operator 112 induced movement) may save the operator 112 time and/or guard against human error and/or forgetfulness.

The present methods and/or systems may be realized in hardware, software, or a combination of hardware and software. The present methods and/or systems may be realized in a centralized fashion in at least one computing system, or in a distributed fashion where different elements are spread across several interconnected computing or cloud systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

As used herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z”.

As utilized herein, the terms “e.g.,” and “for example” set off lists of one or more non-limiting examples, instances, or illustrations.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, circuitry is “operable” and/or “configured” to perform a function whenever the circuitry comprises the necessary hardware and/or code (if any is necessary) to perform the function, regardless of whether performance of the function is disabled or enabled (e.g., by a user-configurable setting, factory trim, etc.).

As used herein, a control circuit may include digital and/or analog circuitry, discrete and/or integrated circuitry, microprocessors, DSPs, etc., software, hardware and/or firmware, located on one or more boards, that form part or all of a controller, and/or are used to control a welding process, and/or a device such as a power source or wire feeder.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor.

The term “power” is used throughout this specification for convenience, but also includes related measures such as energy, current, voltage, and enthalpy. For example, controlling “power” may involve controlling voltage, current, energy, and/or enthalpy, and/or controlling based on “power” may involve controlling based on voltage, current, energy, and/or enthalpy.

As used herein, welding-type refers to welding (including laser welding and/or hot wire welding), cladding (including laser cladding), brazing, plasma cutting, induction heating, carbon arc cutting or gouging, hot wire preheating, and/or resistive preheating.

As used herein, a welding-type tool refers to a tool suitable for and/or capable of welding (including laser welding and/or hot wire welding), cladding (including laser cladding), brazing, plasma cutting, induction heating, carbon arc cutting or gouging, hot wire preheating, and/or resistive preheating.

As used herein, welding-type power refers to power suitable for welding (including laser welding and/or hot wire welding), cladding (including laser cladding), brazing, plasma cutting, induction heating, carbon arc cutting or gouging, hot wire preheating, and/or resistive preheating.

As used herein, a welding-type power supply and/or welding-type power source refers to a device capable of, when input power is applied thereto, supplying output power suitable for welding (including laser welding and/or hot wire welding), cladding (including laser cladding), brazing, plasma cutting, induction heating, carbon arc cutting or gouging, hot wire preheating, and/or resistive preheating; including but not limited to transformer-rectifiers, inverters, converters, resonant power supplies, quasi-resonant power supplies, switch-mode power supplies, etc., as well as control circuitry and other ancillary circuitry associated therewith.

As used herein, disable may mean deactivate, incapacitate, and/or make inoperative. As used herein, enable may mean activate and/or make operational.

Disabling of circuitry, actuators, and/or other hardware may be done via hardware, software (including firmware), or a combination of hardware and software, and may include physical disconnection, de-energization, and/or a software control that restricts commands from being implemented to activate the circuitry, actuators, and/or other hardware. Similarly, enabling of circuitry, actuators, and/or other hardware may be done via hardware, software (including firmware), or a combination of hardware and software, using the same mechanisms used for disabling.

What is claimed is:

1. A non-transitory computer readable medium comprising machine readable instructions which, when executed by a processor, cause the processor to:
move, via a robot, a welding-type tool in a first direction, until a touch sensor detects that the welding-type tool, or a welding electrode configured to receive electric current through the welding-type tool, has made a first contact with a part at a first touch position;
move, via the robot, the welding-type tool in a second direction, until the touch sensor detects that the welding-type tool or the welding electrode has made a second contact with the part at a second touch position; and
identify an intermediate position to which to move the welding-type tool or the welding electrode before seeking a third contact with the part at a third touch position.

2. The non-transitory computer readable medium of claim 1, wherein the touch sensor is configured to detect when the welding electrode touches the part by detecting a short circuit.

3. The non-transitory computer readable medium of claim 1, further comprising machine readable instructions which, when executed by a processor, cause the processor to move, via the robot, the welding-type tool or the welding electrode in an intermediate direction for an intermediate distance to the intermediate position.

4. The non-transitory computer readable medium of claim 3, further comprising machine readable instructions which, when executed by a processor, cause the processor to:
move, via the robot, the welding-type tool or the welding electrode from the first touch position to a first end position;
move, via the robot, the welding-type tool or the welding electrode from the second touch position to a second end position; and
move, via the robot, the welding-type tool or the welding electrode from the second end position to the intermediate position.

5. The non-transitory computer readable medium of claim 3, further comprising machine readable instructions which, when executed by a processor, cause the processor to:
move, via the robot, the welding-type tool in the first direction, from a first starting position, until the touch sensor detects the first contact at the first touch position;
move, via the robot, the welding-type tool in the second direction, from a second starting position, until the touch sensor detects the second contact at the second touch position; and
move, via the robot, the welding-type tool or the welding electrode from the intermediate position to a third starting position.

6. The non-transitory computer readable medium of claim 5, further comprising machine readable instructions which, when executed by a processor, cause the processor to move, via the robot, the welding-type tool or the welding electrode in a third direction, from the third starting position, until the touch sensor detects that the welding-type tool or the welding electrode has made a third contact with the part at a third touch position.

7. The non-transitory computer readable medium of claim 6, wherein the third direction is perpendicular to the first direction and the second direction.

8. The non-transitory computer readable medium of claim 6, further comprising machine readable instructions which, when executed by a processor, cause the processor to:
identify a welding position based on the first touch position, the second touch position, and the third touch position; and
perform a welding-type operation at the welding position using the welding-type tool or the welding electrode.

9. The non-transitory computer readable medium of claim 5, further comprising machine readable instructions which, when executed by a processor, cause the processor to:
identify the intermediate direction based on the first direction and the second direction; and
identify the intermediate position based on the intermediate direction and the third starting position.

10. The non-transitory computer readable medium of claim 9, wherein the intermediate direction is perpendicular to the first direction and the second direction, and the intermediate position and the third starting position are both located in an intermediate plane that is perpendicular to the intermediate direction.

11. A robotic welding system, comprising:
a welding-type tool configured to route electric current to a welding electrode;
a robot configured to manipulate the welding-type tool;
a touch sensor configured to detect when the welding-type tool or the welding electrode touches a part; and
processing circuitry configured to:
move, via the robot, the welding-type tool in a first direction, until the touch sensor detects that the welding-type tool or the welding electrode has made a first contact with the part at a first touch position,
move, via the robot, the welding-type tool in a second direction, until the touch sensor detects that the welding-type tool or the welding electrode has made a second contact with the part at a second touch position, and
identify an intermediate position to which to move the welding-type tool or the welding electrode before seeking a third contact with the part at a third touch position.

12. The robotic welding system of claim 11, wherein the touch sensor is configured to detect when the welding electrode touches the part by detecting a short circuit.

13. The robotic welding system of claim 11, wherein the processing circuitry is further configured to move, via the robot, the welding-type tool or the welding electrode in an intermediate direction for an intermediate distance to the intermediate position.

14. The robotic welding system of claim 13, wherein the processing circuitry is configured to:
move, via the robot, the welding-type tool or the welding electrode from the first touch position to a first end position,
move, via the robot, the welding-type tool or the welding electrode from the second touch position to a second end position, and
move, via the robot, the welding-type tool or the welding electrode from the second end position to the intermediate position.

15. The robotic welding system of claim 13, wherein the processing circuitry is configured to:
move, via the robot, the welding-type tool in the first direction, from a first starting position, until the touch sensor detects the first contact at the first touch position,
move, via the robot, the welding-type tool in the second direction, from a second starting position, until the touch sensor detects the second contact at the second touch position, and
move, via the robot, the welding-type tool or the welding electrode from the intermediate position to a third starting position.

16. The robotic welding system of claim 15, wherein the processing circuitry is further configured to move, via the robot, the welding-type tool or the welding electrode in a third direction, from the third starting position, until the touch sensor detects that the welding-type tool or the welding electrode has made a third contact with the part at a third touch position.

17. The robotic welding system of claim 16, wherein the third direction is perpendicular to the first direction and the second direction.

18. The robotic welding system of claim 16, wherein the processing circuitry is further configured to:
identify a welding position based on the first touch position, the second touch position, and the third touch position, and
perform a welding-type operation at the welding position using the welding-type tool or the welding electrode.

19. The robotic welding system of claim 15, wherein the processing circuitry is configured to:
identify the intermediate direction based on the first direction and the second direction, and
identify the intermediate position based on the intermediate direction and the third starting position.

20. The robotic welding system of claim 19, wherein the intermediate direction is perpendicular to the first direction and the second direction, and the intermediate position and the third starting position are both located in an intermediate plane that is perpendicular to the intermediate direction.
